(19) United States
(12) Patent Application Publication
(10) Pub. No.: US 2008/0202282 A1
(43) Pub. Date: Aug. 28, 2008

(54) Vehicle Steering Wheel and Method For Making Same

(75) Inventors: Kevin S. Bassett, East Grand Rapids, MI (US); Daniel L. Schlenk Jr., Grand Rapids, MI (US); Brendan J. Fitzgerald, Cedar Springs, MI (US); Timothy R. Mabie, Cedar Springs, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Spectrum Cubic, Inc., Grand Rapids, MI (US)

(21) Appl. No.: 11/915,052

(22) PCT Filed: May 24, 2006
(86) PCT No.: PCT/US2006/020125

§ 371 Date: Nov. 20, 2007

Related U.S. Application Data
(60) Provisional application No. 60/684,379, filed on May 25, 2005.

(51) Int. Cl. B62D 1/04; G05G 1/10; G06F 19/00

(52) U.S. Cl. 74/552; 700/117

(57) ABSTRACT

A steering wheel comprises a base member including a grip base, a first layer disposed about a portion of the grip base, and a second layer disposed about a portion of the first layer, with the second layer being constructed to enable the first layer to be at least partially visible through the second layer. Optionally, the steering wheel may include at least one insert layer including a cavity and a decorative member adapted to being at least partially disposed within the cavity. A cover layer may be disposed about at least a portion of the insert layer such that the decorative member is substantially encapsulated by the cover layer within the cavity. The decorative member may be either a light-emitting device or an ornamental insert that is visible through the cover layer. Coatings may also be applied to the steering wheel to provide additional styling elements.

### CROSS REFERENCE TO RELATED APPLICATION

The present application claims priority on U.S. provisional application Ser. No. 60/684,379, filed May 25, 2005, by Kevin S. Bassett, et al. for a VEHICLE STEERING WHEEL AND METHOD OF MAKING SAME, which is hereby incorporated herein by reference in its entirety.

### BACKGROUND OF THE INVENTION

The present invention is directed to steering wheels for use in automotive vehicles, and in particular to the inclusion of distinguishing functional and/or aesthetic components to steering wheels.

Automotive vehicle manufacturers seek to add consumer desirable content and distinguishing features to the vehicles that they produce in order to increase the popularity and sales of the vehicles. Within the interior of the vehicle, a particular focus of vehicle manufacturers is the driver's control area, including the steering wheel and dashboard.

Presently, steering wheels are designed to include grip portions adapted to be grasped by the drivers of the vehicles, with the grip portions being generally ring-shaped and affixed to a steering wheel center by spokes or arms. Steering wheels often include an airbag and may include cruise control and/or stereo controls, or the like. The grip portions of steering wheels may have outer surfaces that are wrapped with leather or synthetic cloth, and/or may be constructed of polymeric materials.

One method of adding distinguishing content to steering wheels is by applying a printed design pattern to the outside surface of the grip portion. U.S. Pat. No. 4,010,057 issued to Nakanishi discloses a printing apparatus that prints patterns such as wood grain patterns onto polymeric products. A thin film having a pattern floats on the surface of a liquid and the product to be printed is submerged into the liquid such that the pattern is applied to the product. The application of this type of printing material and printing method with respect to steering wheels is known and provides a visually appealing surface.

In order to continually improve and advance automotive designs, however, the addition of further distinguishing design features to vehicles is desirable, including the addition of unique design features to the steering wheels of vehicles.

### SUMMARY OF THE INVENTION

The present invention provides a steering wheel for an automotive vehicle that includes unique structural components that, in addition to forming part of the grip portion of the steering wheel for the driver to grasp while driving, provide additional functional and/or design cues to the steering wheel. In one embodiment of the present invention, a steering wheel includes a first layer disposed about a grip base of a steering wheel with a second layer disposed about the first layer. The second layer may be constructed to be either transparent or translucent such that the first layer is at least partially visible through the second layer, with the first layer being transparent, translucent, or opaque. A coating may also be disposed about the second layer. In another embodiment of the present invention, a steering wheel includes an insert layer disposed about a grip base of a steering wheel base member, with the insert layer including a cavity adapted to receive a decorative member. The decorative member may be of various constructions, such as light emitting or a complimenting decorative color or the like, in order to provide an aesthetic and/or a functional benefit to the occupants of the vehicle. A cover layer may then be disposed about the insert layer and the cover layer may further include a coating. Alternatively, one or both of the decorative member and insert layer may be provided with a coating and the cover layer omitted.

According to one aspect of the present invention, a steering wheel for vehicles comprises a base member including a grip base and a grip portion at least partially disposed about the grip base. The grip portion comprises an insert layer including a cavity forming an opening on an outer surface of the insert layer at least partially disposed about the grip base and a decorative member. The decorative member is adapted to being disposed within the cavity such that the decorative member includes an exposed surface relative to the insert layer, the decorative member and the insert layer are at least partially visible when the decorative member is disposed within the cavity.

According to another aspect of the present invention, a method of producing a steering wheel comprises providing a base member having a grip base, forming an insert layer about at least a portion of the grip base, and forming a cavity in the insert layer, the cavity defining an opening on an outer surface of the insert layer. The method further comprises providing a decorative member for installation to the steering wheel and inserting the decorative member into the cavity such that the decorative member includes an exposed surface relative to the insert layer.

According to another aspect of the present invention a steering wheel for vehicles comprises a base member having a grip base, at least one insert layer, each of which includes at least one cavity, at least one decorative member adapted to being at least partially disposed within the cavity, and at least one cover layer. The at least one cover layer is disposed about at least a portion of the insert layer and the decorative member is substantially encapsulated within the cavity.

According to another aspect of the present invention, a method of producing a steering wheel comprises forming at least one insert layer having at least one cavity, inserting at least one decorative member in the at least one cavity, and forming at least one cover layer about at least a portion of the at least one insert layer with the decorative member being substantially encapsulated within the cavity.

According to yet another aspect of the present invention, a steering wheel for vehicles comprises a base member that includes a grip base, a first layer that is disposed about at least a portion of the grip base, and a second layer that is disposed about at least a portion of the first layer. The second layer is adapted to enable the first layer to be at least partially visible through the second layer.

According to still another aspect of the present invention, a method of producing a steering wheel comprises forming a first layer about at least a portion of the grip base of a base member and forming a second layer about at least a portion of the first layer with the second layer being adapted to enable the first layer to be at least partially visible through the second layer.

According to yet another aspect of the present invention a steering wheel for vehicles comprises a base member that includes a grip base, a first layer constructed of an elastomeric material adapted to provide absorption of impact forces disposed about at least a portion of the grip base, and a second layer disposed about at least a portion of the first layer.

According to still another aspect of the present invention, a method of producing a steering wheel comprises forming a first layer about at least a portion of the grip base of a base member, the first layer being constructed of an elastomeric material adapted to provide absorption of impact forces, and forming a second layer about at least a portion of the first layer such that at least a portion of the first layer is substantially encapsulated by the second layer.

The steering wheel of the present invention enhances the vehicle to which it is installed by adding visibly distinguishing content to the interior of the vehicle while forming a segment of the grip portion of the steering wheel. The additional content may be visible as a multi-layered steering wheel with at least one of the layers being transparent or translucent such that an inner layer is at least partially visible. The various layers may be tinted with hues to provide stylistic design cues that compliment the interior of the vehicle. The additional content may also be visible as a decorative member configured as either a light-emitting device or an ornamental insert embedded within the steering wheel. The decorative member constructed as a light-emitting device may also provide functional benefits by supplying added light to the occupants of a vehicle when the occupants are entering or alighting the vehicle, or by functioning as a map light, or as a turn signal indicator or the like. Numerous differently styled decorative members constructed as ornamental inserts may be used to provide various aesthetically appealing additions to the steering wheel. The steering wheel including a decorative member may or may not also include a cover layer disposed over the layer containing such decorative members, and may also include layers that are either transparent or translucent, with such layers optionally including hues adapted to match the coloring of the interior of the vehicle, that enable the decorative members to be at least partially visible. The application of a coating to the outer surface of the steering wheel and/or to a decorative member provides further visually distinguishing design details to the steering wheel.

These and other objects, advantages, and features of the present invention will become apparent upon review of the following specification in conjunction with the drawings.

### BRIEF DESCRIPTION OF THE DRAWINGS

FIG. 1 is a perspective view of one embodiment of a steering wheel according to the present invention;

FIG. 1A is a perspective view of an alternative embodiment of a steering wheel according to the present invention;

FIG. 2 is a cross-sectional partial perspective view of the first grip portion of FIG. 1, with the various layers of the first grip portion displayed in partially removed tiered relationship for illustrative purposes;

FIG. 2A is a cross-sectional partial perspective view of the first grip portion of FIG. 1A, with the various layers of the first grip portion displayed in partially removed tiered relationship for illustrative purposes;

FIG. 3 is a perspective view of the base member of the steering wheel of FIG. 1;

FIG. 4 is a partial perspective view of an insert layer disposed on the grip member of a grip base;

FIG. 5 is a partial perspective view of an alternative insert layer;

FIG. 6 is a partial perspective view of an alternative insert layer;

FIG. 7 is a partial perspective view of an alternative insert layer;

FIG. 8 is a perspective view of a decorative member installed within the insert groove of the insert layer of FIG. 4;

FIG. 9 is a perspective view of an alternative decorative member;

FIG. 10 is a partial perspective view of an alternative insert layer and decorative member, with the various layers displayed in partially removed tiered relationship for illustrative purposes;

FIG. 10A is a partial perspective view of another alternative insert layer and decorative member, with the various layers displayed in partially removed tiered relationship for illustrative purposes;

FIG. 11 is a perspective view of a cover layer disposed over the decorative member and insert layer of FIG. 8;

FIG. 12 is a perspective view of a coating disposed over the cover layer of FIG. 11;

FIG. 13 is a perspective view of another steering wheel according to the present invention;

FIG. 14 is a partial perspective view of the insert layer of the steering wheel of FIG. 13 disposed on the grip member of the grip base;

FIG. 15 is a cross-sectional, partial perspective view of the first grip portion of FIG. 13 shown without the decorative member and with the various layers of the first grip portion displayed in partially removed, tiered relationship for illustrative purposes;

FIG. 16 is a partial perspective view of the decorative member of the steering wheel of FIG. 13; and

FIG. 17 is a cross-sectional view of the first grip portion of the steering wheel of FIG. 13 taken along plane XVII of FIG. 13.

### DESCRIPTION OF THE PREFERRED EMBODIMENT

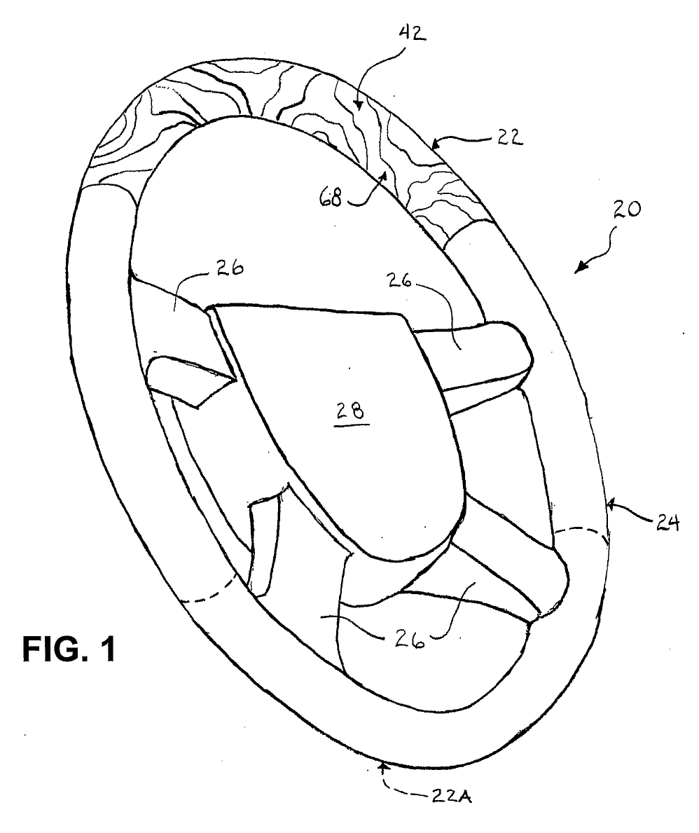

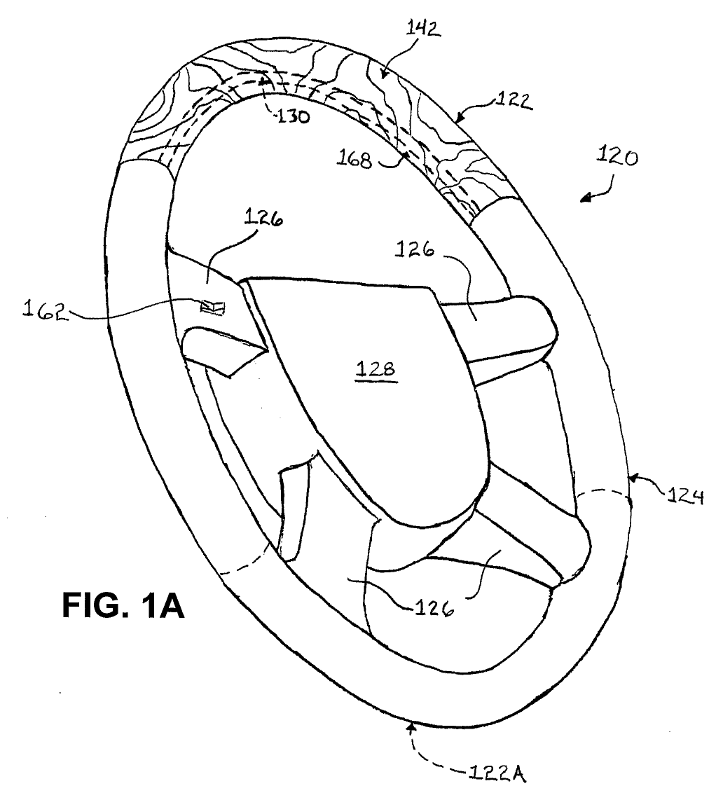

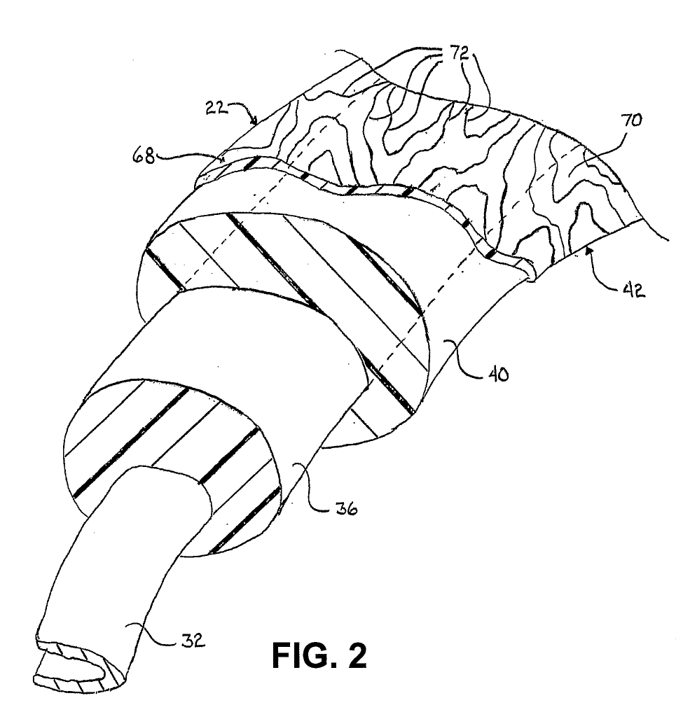

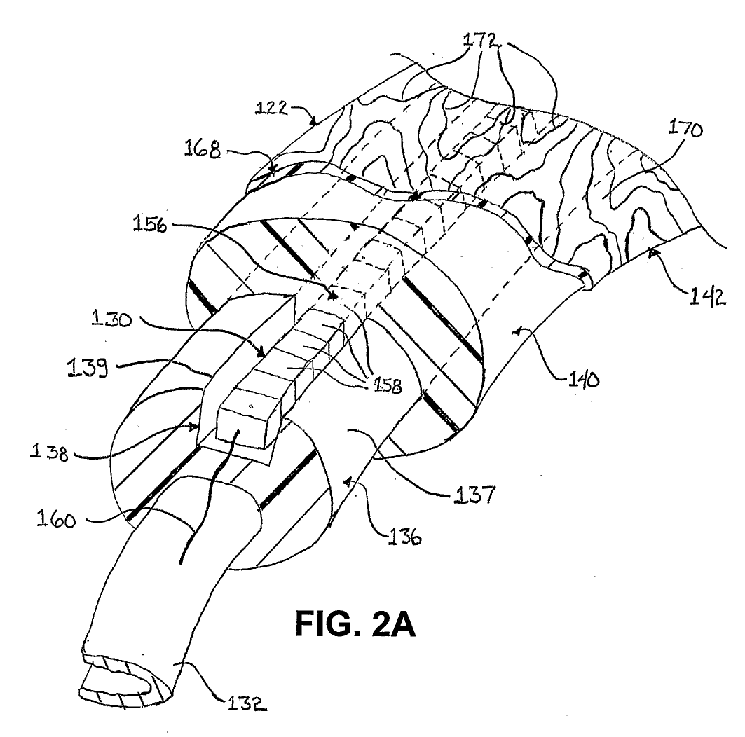

Referring now specifically to the drawings, and the illustrative embodiments depicted therein, a steering wheel 20 of the present invention is shown in FIG. 1 to include a first grip portion 22, a second grip portion 24, multiple steering arms 26, and a steering wheel center 28. As illustrated, first grip portion defines an arc of approximately 130 degrees and second grip portion defines an arc of approximately 230 degrees such that together first and second grip portions form a generally ring-shaped structure that is grasped by a driver to steer a vehicle. As illustrated in FIG. 2, the components forming first grip portion 22 include a shaft or rod member or grip base 32 that is affixed to a base member 34 (FIG. 3), where grip base 32 forms the generally 360 degrees circumferential base for first and second grip portions 22, 24. First grip portion also includes an inner layer or primary layer or first layer 36, a cover layer or secondary layer or second layer or outer layer 40, and a decorative coating or coating 42 that is optionally applied. In the illustrated embodiment, coating 42 is a transfer film 68 having a pre-selected ink pattern 70 incorporating lines 72 and is of generally similar construction to transfer film 168 of FIG. 2A, which is described in more detail below.

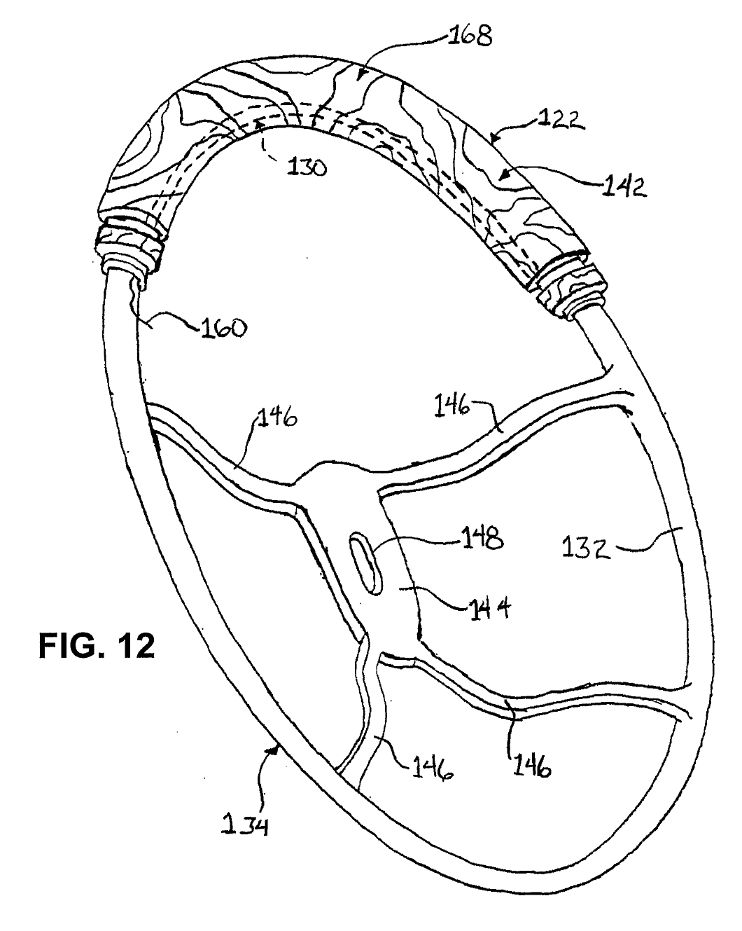

An alternative steering wheel 120 is shown in FIG. 1A that is of similar construction to steering wheel 20, where similar components or elements are shown with similar reference numerals as used in regard to steering wheel 20, but with 100 added to the reference numbers. First grip portion 122 of steering wheel 120 includes, as shown in phantom in FIG. 1A, a decorative member or filling 130. Decorative member 130, as described in detail below, is substantially embedded within first grip portion 122 below translucent or transparent layers such that it is visible to occupants of the vehicle in which steering wheel 120 is installed. Decorative member 130, as also described below, may be of various constructions, such as light emitting or a complementing decorative color or the like, in order to provide an aesthetic and/or a functional benefit to the occupants of the vehicle. In addition to decorative member 130, as illustrated in FIG. 2A, the components forming first grip portion 122 include a shaft or rod member or grip base 132 that is affixed to a base member 134 (FIG. 12), an insert layer or primary layer or first layer 136 having a notch or recess or channel or cavity 138, a cover layer or secondary layer or second layer 140, and a decorative coating or coating 142 that is optionally applied.

FIG. 3 discloses base member 34, which is adapted for use as a central foundation or skeleton for steering wheel 20. In addition to grip base 32, base member 34 also includes a base plate 44, and multiple base arms 46 joining grip base 32 to base plate 44. Base plate 44 includes a mounting hole 48 used to affix a fully assembled steering wheel 20 to the steering column of a vehicle. Although not shown, base plate 44 may also include additional mounting holes or other receiving points for assembling the various components of the steering wheel 20, such as an air bag (not shown), a horn activating mechanism (not shown), or electrical components (not shown). Base arms 46 extend outwardly and upwardly from base plate 44 to grip base 32 such that base plate 44 and grip base 32 are located in separate planes and base member 34 and the resulting steering wheel have an overall dish shape. Base arms 46 are used as a foundation for steering arms 26.

Grip base 32, as illustrated in FIG. 3, is formed to be substantially ring-shaped in the traditional manner of steering wheels. It should be understood, however, that grip base 32 may be alternatively shaped and still function as intended within the scope of the present invention. FIG. 2 shows grip base 32 to have a U- or V-shaped cross-sectional profile, where such a profile functions, in part, to provide additional strength to grip base 32 and mechanical bonding of first layer 36 to grip base 32. However, grip base 32 may be formed with alternative cross-sectional profiles and still function as intended within the scope of the present invention. Grip base 32, for example, could be constructed to have a circular, or X-shaped, or W-shaped profile, or the like. Base member 34 is preferably die cast and constructed from magnesium, zinc, aluminum, or alloys of such metals. It should also be appreciated that base member 34 may alternatively be constructed of other metals or alloys or even polymeric materials and/or formed by other processes and still function as intended.

Steering wheel 20 is of substantially similar construction to steering wheel 120 except for the inclusion in wheel 120 of cavity 138 in first layer 136, and the installation of decorative member 130 within cavity 138. The following description, therefore, will focus on steering wheel 120, but it should be understood that the various alternatives discussed regarding the materials, means for forming, and overall configuration of steering wheel 120 that are unrelated to cavity 138 and decorative member 130 are equally applicable to steering wheel 20.

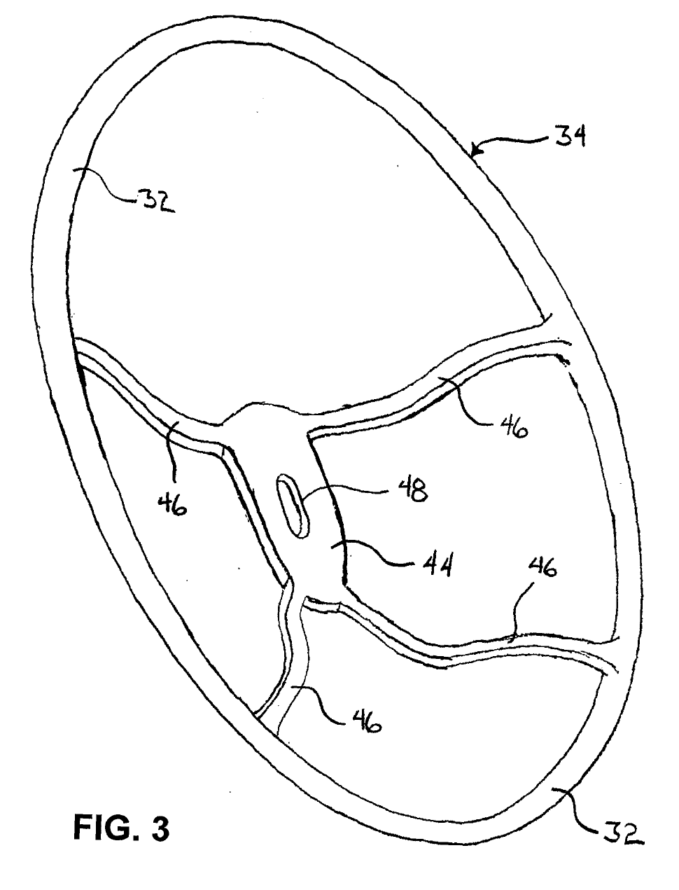

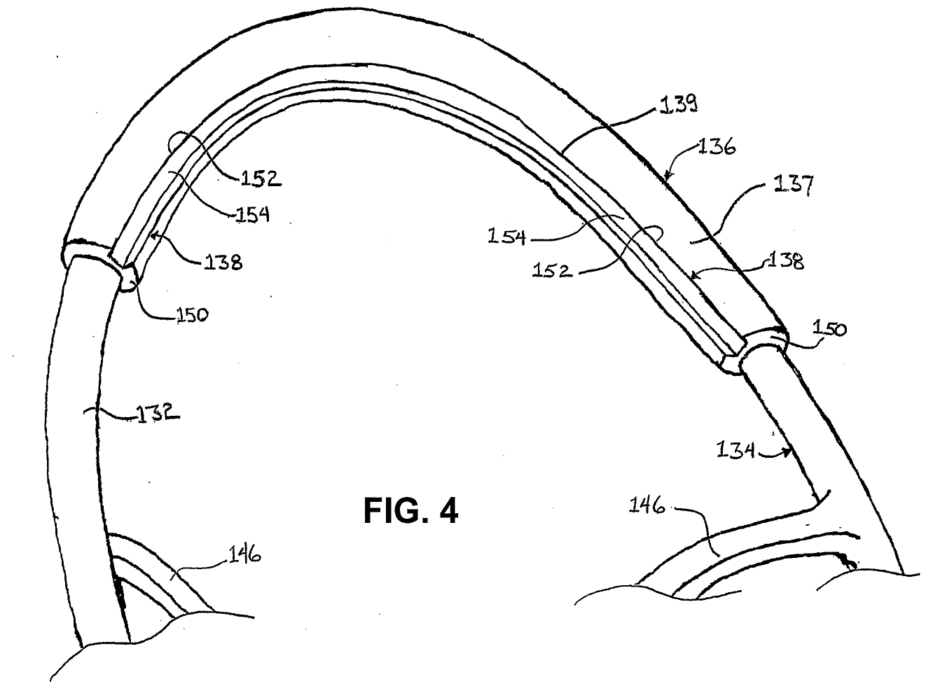

FIG. 4 illustrates first layer 136 of steering wheel 120 applied to a portion of grip base 132 with cavity 138 being formed within first layer 136. Cavity 138 forms an opening 139 in an outer surface 137 of first layer 136. First layer 136, as shown, is disposed circumferentially about grip base 132 to define an arc of approximately 130 degrees between the spaced ends 150 of first layer 136. Optionally, other first layers 136 may be alternatively constructed to define either a smaller or larger arc about grip base 132, and may even fully surround grip base 132 with base arms 146 extending out of first layer 136 in such an embodiment. Still further, as described in more detail below, two or more separate first layers 136 could be disposed in spaced relationship to one another about grip base 132. For example, a first layer 136 could be disposed about grip base 132 in an approximately ten o'clock to two o'clock relative orientation and a separate additional first layer 136 could be disposed about the same grip base 132 in an approximately four o'clock to eight o'clock relative orientation.

As best understood from FIGS. 2A and 4, first layer 136 surrounds the cross-sectional profile of grip base 132 such that no part of grip base 132 is exposed between the spaced ends 150. Similarly, alternative first layers 136 could be formed that do not fully surround the cross-sectional profile of grip base 132, thus exposing a portion of the grip base 132 with respect to the first layer 136 between the spaced ends 150. It should be appreciated that such alternative first layers 136 would still be able to function as intended within the scope of the present invention.

The cavity 138 disclosed in FIGS. 2A and 4 is formed as an insert groove or channel 152 extending between spaced ends 150 along the entire length of the arc of first layer 136 and is oriented generally parallel to grip base 132. As illustrated, the base 154 of insert groove 152 is spaced above or away from grip base 132 such that, as discussed above, no part of grip base 132 between spaced ends 150 is exposed. Also as shown, insert groove 152 is constructed to have a generally rectangular or square cross-sectional profile. As noted above and discussed more fully below, insert groove 152 is adapted to receive variously configured decorative members 130.

First layer 136 is preferably constructed of an opaque, polymeric or plastic material, such as acrylic urethane, that is applied to grip base 132 by known injection molding processes such that cavity 138 is simultaneously formed. For example, the portion of grip base 132 to which first layer 136 is to be applied may be positioned within a mold having a mold cavity designed to form a desired size and shape for first layer 136 and cavity 138. The polymeric material may then be injected into the mold cavity such that first layer 136 and cavity 138 are formed. Upon removal, excess polymeric material may be trimmed off if necessary. Rather than forming cavity 138 during the molding process, however, cavity 138 may also be alternatively formed by machining processes such as, for example, grinding, boring, drilling, broaching, milling, or honing, after a first layer 136 has been applied to grip base 132.

First layer 136 may be constructed of alternative materials such as, for example, alternative polymeric materials or a metallic material or glass material or wood material, and still function as intended within the scope of the present invention. The alternative polymeric materials could be, amongst others, ABS, polycarbonates, PC/ABS, phenolics, polypropylenes, or the like. Such alternative materials may be applied by molding processes, or may be pre-formed and affixed to grip base 132 by mechanical fasteners, or the like.

First layer 136, as noted above, is preferably constructed to be opaque such that grip base 132 is not visible between spaced ends 150. As described more fully below, first layer 136 is at least partially visible through coating 142 and second layer 140. Therefore, first layer 136 may be constructed to have one or more exterior surface colors chosen based on design appearance criteria for steering wheel 120. However, although preferably opaque, first layer 136 may also be constructed to be at least translucent, partially translucent, partially transparent, or fully transparent.

Although FIGS. 2A and 4 disclose insert groove 152 as having a generally rectangular profile and as extending between spaced ends 150, it should be appreciated that numerous other cavity 138 configurations may be formed in first layer 136 and still function as intended within the scope of the present invention. For example first layer 136 may include more than one cavity 138, or may be formed to have a semi-circular or V-shaped profile, or may be alternatively oriented relative to grip base 132, or the like. In addition, alternative insert grooves 152 could be constructed that expose a portion of the grip base 132 with respect to first layer 136 between spaced ends 150.

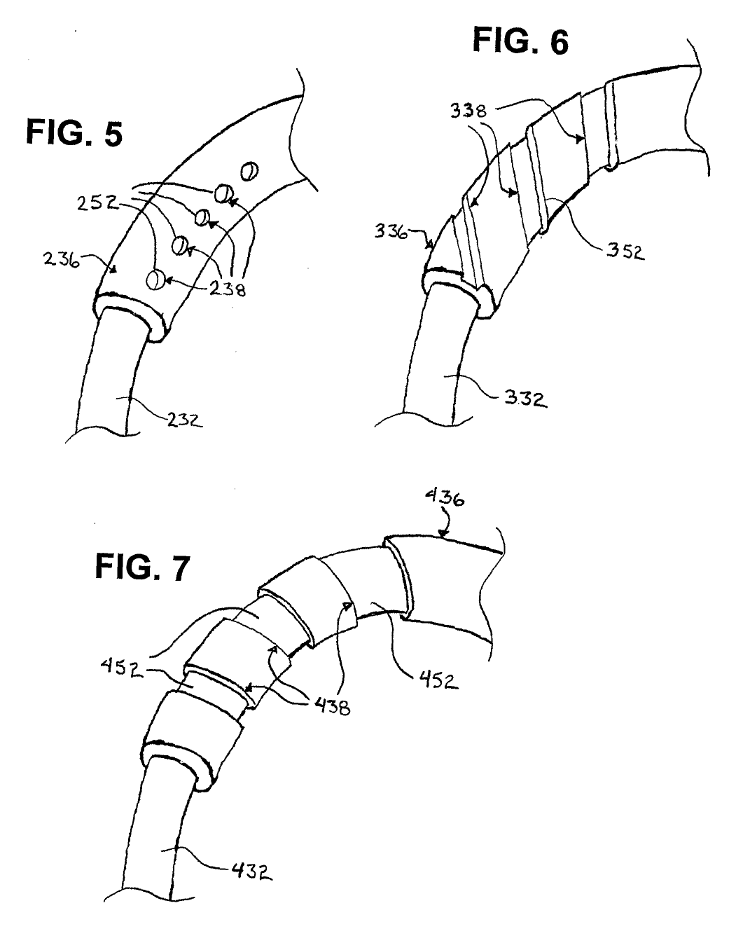

Examples of optionally configured cavities are shown in FIGS. 5 to 7 and disclose alternative cavities 238, 338, 438 formed in first layers 236, 336, 436 disposed about grip bases 232, 332, 432. FIG. 5 discloses cavities 238 formed as multiple, generally circularly-shaped cylinders 252. FIG. 6 discloses cavity 338 as a groove 352 formed to have a generally helical or spiral orientation about grip base 332. FIG. 7 discloses cavities 452 as multiple, circular insert grooves 452 oriented such that each circular insert groove 452 surrounds grip base 432. The various cavities 238, 338, 438 may or may not be constructed to have depths sufficient to expose portions of grip base 232, 332, 432.

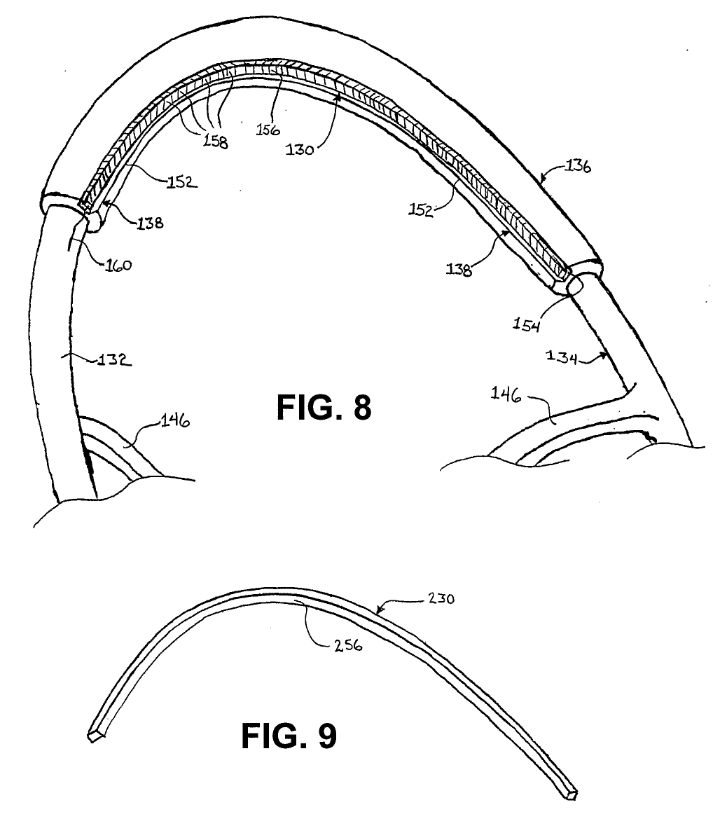

FIGS. 2A and 8 illustrate decorative member 130 disposed or inserted within cavity 138 of first layer 136. In the embodiment shown, decorative member 130 is constructed as a light-bar or light-strip or light-emitting device 156 having multiple light projectors 158 that are supplied with current through electrical lines 160. As previously noted, decorative member 130 is covered by layers that are at least partially translucent or transparent such that the light produced by light-emitting device 156 is observable by occupants of the vehicle within which steering wheel 120 is installed. Light-emitting device 156 may be constructed to include a housing (not shown) within which light projectors 158 are housed. The light projectors 158 may be light-emitting diodes (LED's), fiber optic strands or cables, or the like.

Light-emitting device 156 may be constructed to be activated to selectively emit light by the driver or occupant of the vehicle within which steering wheel 120 is installed by operating dial or switch 162 located on steering wheel 120 (FIG. 1), with switch 162 being in electrical communication with light-emitting device 156 through lines 160. Switch 162 may be constructed to function as a dimmer switch whereby light-emitting device 156 could be controlled to emit selective levels of light, in addition to being selectively turned fully on or off. Alternatively or additionally, light-emitting device 156 could be operated in connection with the headlights of the vehicle such that whenever the headlights were activated, either by the driver or by ambient light sensors, light-emitting device 156 would be activated. Similarly, light-emitting device 156 could be operated in combination with interior vehicle lights, such as a dome light or map light, and be activated upon the opening of a door of the vehicle.

Light-emitting device 156 could also be constructed to be activated in connection with the vehicle's turn signal switch such that light-emitting device 156 provided information to the driver that the turn signals were presently activated. In this embodiment, light-emitting device 156 could be adapted such that only certain portions or certain light projectors 158 were activated depending upon whether the turn signal switch was positioned to indicate either a right or left turn.

Light-emitting device 156, as shown in FIGS. 2A and 8, is sized to be slightly smaller than groove 152. However, light-emitting device 156 could be formed to completely fill groove 152 or even partially extend out of groove 152 and still function as intended. Similarly, although FIG. 8 discloses a single light-emitting device 156 incorporated within groove 152 of first layer 136, it should be appreciated that multiple, variously configured light-emitting devices 156 could be installed to first layer 136 and still function as intended within the scope of the present invention. For example, alternative light-emitting devices (not shown) could be constructed for installation into the cavities 238, 338, 438 disclosed in FIGS. 5-7. Although light-emitting device 156 is shown to have a generally rectangular cross-sectional profile, light-emitting devices may also be formed to have other profiles, such as cylindrical, rounded or the like. When light-emitting devices 156 are used in connection with a turn signal switch, as described above, separate light-emitting devices may be positioned proximate each of the spaced apart ends 150 of first layer 136 to provide a spatial indication to the driver regarding the turning direction. Decorative member 130 may be secured within cavity 138 by a friction fit, mechanical fasteners, an adhesive, clips, tabs, or the like prior to forming second layer 140 about first layer 136 and decorative member 130 in the manner described below.

FIG. 9 illustrates an alternative decorative member 230 constructed as an ornamental insert 256 for use with steering wheel 120 that is also adapted to be installed into groove 152. Ornamental insert 256 may be formed of a metallic material, such as copper, to provide an aesthetic visual appearance to steering wheel 120. Alternatively, ornamental insert 256 may be constructed of a colored polymeric material selected to provide a visual contrast relative to the appearance of first layer 136 and/or match the interior color of a vehicle. Similar to above, decorative member 230 may be secured within cavity 138 by a friction fit, mechanical fasteners, an adhesive, clips, tabs, or the like prior to forming second layer 140 about first layer 136 and decorative member 230.

Although ornamental insert 256 is disclosed as being a unitary piece with a generally rectangular cross-sectional profile, it should be appreciated that numerous alternatively styled ornamental inserts 256 could be utilized with steering wheels 120 that function as intended within the scope of the present invention. For example, multiple alternative ornamental inserts (not shown) could be constructed for placement in cavities 238, 338, 438, of FIGS. 5-7, or could be constructed to completely fill or even extend partially out of a cavity. Furthermore, alternative ornamental inserts could be constructed to have differently shaped cross-sectional profiles, or be formed to have generally sinuous shapes or other such geometrical patterns. Optionally, an alternative steering wheel (not shown) may be formed using both a decorative member 130 constructed as a light-emitting device 156 and a decorative member 230 constructed as an ornamental insert 256.

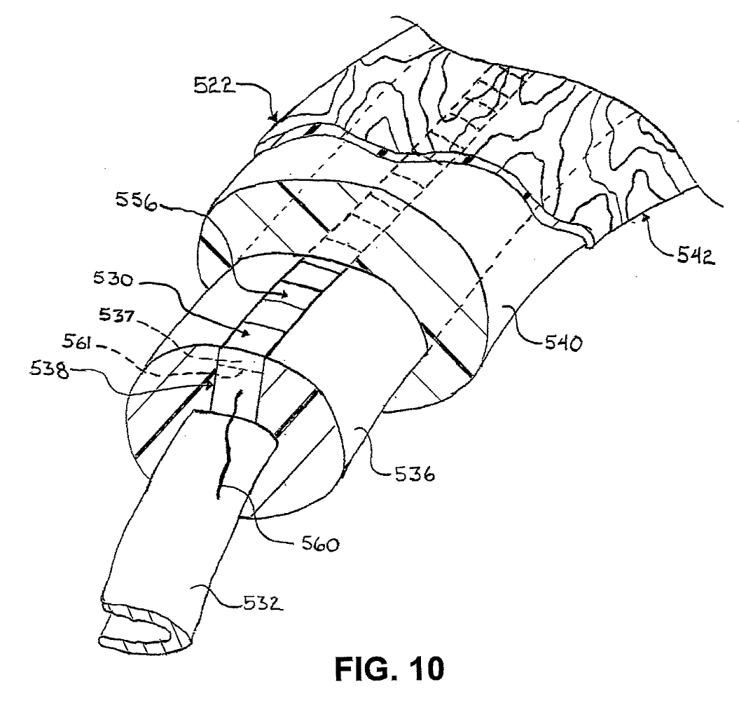

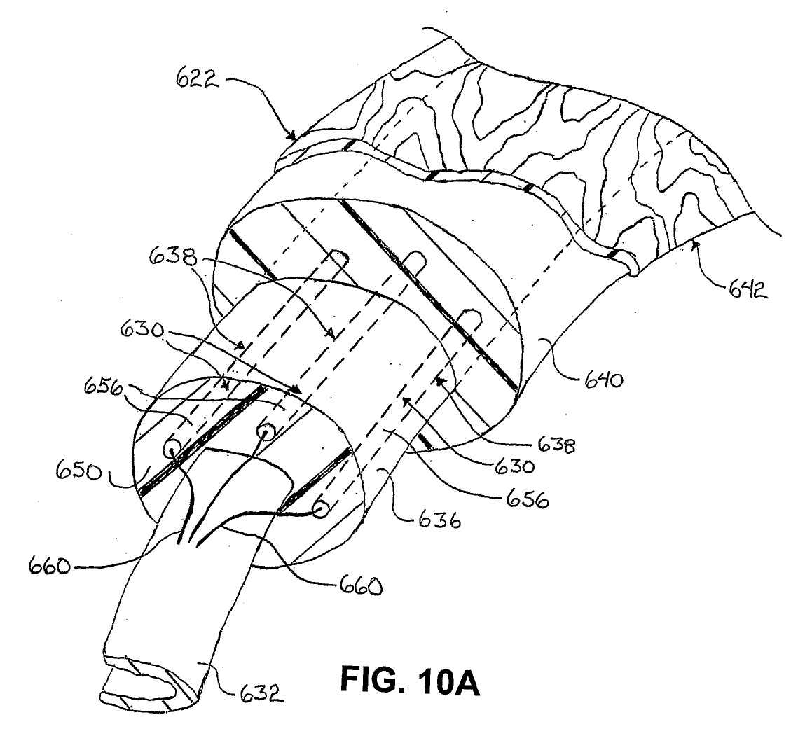

FIG. 10 discloses another embodiment of a first grip portion 522 having an alternative insert layer or first layer 536 formed about grip base 532 and including decorative member 530 constructed as a light-emitting device 556 positioned within cavity 538. First grip portion 522 is of substantially similar construction to first grip portion 122 of steering wheel 120, except with regard to the formation of cavity 538 and as noted below, where similar components or elements are shown with similar reference numerals as used in regard to first grip portion 122, but with 400 added to the reference numerals. It should be understood, therefore, that the various alternatives discussed regarding the materials and overall configuration of first grip portion 122 that are unrelated to cavity 538 are equally applicable to first grip portion 522. Also as illustrated in FIG. 10, first grip portion 522 includes a cover or second layer 540 and an optional coating 542, with second layer 540 and coating 542 constructed in similar manner as described below in regard to the similar components of first grip portion 122.

As illustrated, decorative member 530 contacts grip base 532 such that cavity 538 is formed as a gap in first layer 536, with first layer 536 having a generally C-shaped cross-sectional profile about grip base 532. First layer 536 may be applied to grip base 532 using an insert molding process. In such a process, decorative member 530 is initially affixed to grip base 532 using an adhesive. The grip base 532 having decorative member 530 affixed thereto may then be placed within a mold cavity and a polymeric material injected into the mold cavity to form first layer 536 about decorative member 530. Decorative member 530 may alternatively be secured to grip base using threaded fasteners, clips, snaps, or the like, prior to forming first layer 536.

FIG. 10 also illustrates that first layer 536 may alternatively be disposed over decorative member 530 such that decorative member 530 is substantially encapsulated by first layer 536. As shown, the surface or edge or side 561 (shown in phantom) of light-emitting device 556 would be below or underneath or surrounded by a portion or bridge 537 of first layer 536. First layer 536 in this embodiment would preferably be constructed of a transparent or translucent material such that decorative member 530 would be at least partially visible through the portion of first layer 536. Still further, first layer 536 could be alternatively constructed to cover portions of decorative member 530 while exposing other portions.

Although decorative member 530 is disclosed as a light-emitting device 556 in FIG. 10, it should be appreciated that alternative decorative members (not shown) may also be used as shown in FIG. 10. For example, an ornamental insert that does not emit light could be employed. Still further multiple decorative members could be disposed on or about grip base 532 that either surround the cross-sectional profile of grip base 532, or extend parallel to grip base 532, or are placed in discreet locations on grip base 532.

FIG. 10A discloses still another embodiment of a first grip portion 622 having an alternative insert layer or first layer 636 formed about grip base 632 and including decorative members 630 constructed as light-emitting devices 656 positioned within cavities 638. First grip portion 622 is of substantially similar construction to first grip portion 122 of steering wheel 120, except with regard to the formation of cavities 638 and the construction of light-emitting devices 656, and as noted below. Therefore, similar components or elements are shown with similar reference numerals as used in regard to first grip portion 122, but with 500 added to the reference numerals. The various alternatives discussed regarding the materials and overall configuration of first grip portion 122, therefore, are also applicable to first grip portion 622. Also as illustrated in FIG. 10A, first grip portion 622 includes a cover or second layer 640 and an optional coating 642, with second layer 640 and coating 642 constructed in similar manner as described below in regard to the similar components of first grip portion 122.

As illustrated, cavities 638 are formed as generally circular cylinders or holes extending within first layer 636 in a generally parallel relationship to grip base 632, with one end of the cavities 638 positioned at end 650 of first layer 636. Cavities 638 may be formed within first layer 636 by forming a hole, such as by drilling with a drill bit or the like, into end 650. Light-emitting devices 656, constructed as LED's or the like, are then inserted into cavities with leads or wires 660 extending out of ends 650.

First layer 636 may be constructed of a transparent or a translucent material such that, when light-emitting devices 656 are illuminated, at least a portion of the light waves produced by light-emitting devices 656 travel along and within first layer 636 with first layer 636 thus functioning as a conduit or path or light pipe for the light waves about grip base 632. First layer 636 is thereby provided with the appearance of being an illuminated object beneath second layer 640.

The degree of luminosity of first layer 636 may decrease along the length of first layer 636 away from end 650 depending upon the type of material selected for first layer 636 and the number, level of brightness, and length of light-emitting devices 656 used with first grip portion 622. Therefore, although not shown, similar cavities 638 may be formed within the opposite end (not shown) of first layer 636, with such cavities 638 also being provided with light-emitting devices 656.

Although shown as including three cavities 638 and three light-emitting devices 656, it should be appreciated that more or fewer cavities 638 and light-emitting devices 656 may be used and still enable first grip portion 622 to function as intended. In addition, cavities 638 and light-emitting devices 656 may be constructed to extend various lengths within first layer 636 relative to end 650. Furthermore, decorative members 630 may be alternatively constructed as non-illuminating ornamental inserts.

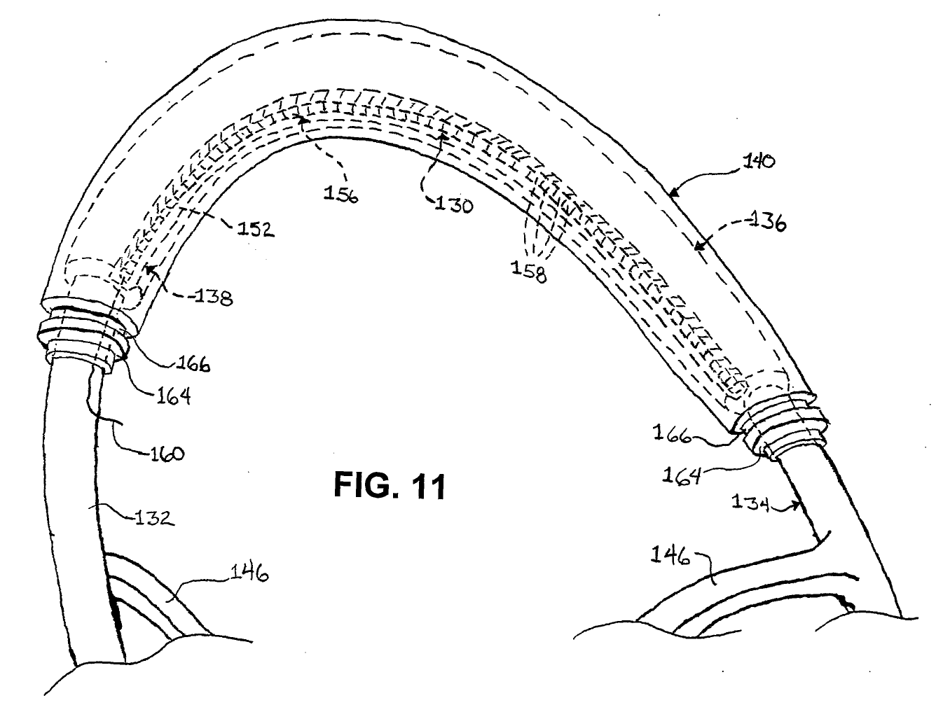

Returning to first grip portion 122 of steering wheel 120, FIGS. 2A and 11 disclose second layer 140 applied to or disposed about first layer 136 and decorative member 130 with second layer 140 encapsulating first layer 136 and decorative member 130 between spaced ends 164 of first layer 136 such that only lines 160 of decorative member 130 extend beyond one of the spaced ends 164 of second layer 140. Second layer 140 also includes tuck grooves 166 located at ends 164. Tuck grooves 166 are used as an attachment point for portions of second grip portion 124 (FIG. 1A), where second grip portion 124 may include a polyurethane underlayment covered by a leather or synthetic leather wrapping. Lines 160 may be covered by second grip portion 124 and extend within steering arms 126 such that they may be connected with switch 162. Although not shown, second layer 140 may also include finger recesses adapted to conform to the palm side of a driver's fingers when steering wheel 120 is grasped by a driver, with the finger recesses thus providing additional gripping traction in a known manner.

Second layer 140 may be constructed of a polymeric or plastic material, such as an acrylic urethane, that is either translucent or transparent, where second layers 140 may be tinted with hues adapted to compliment the coloring of the interior of the vehicle. Depending upon the degree of translucency or transparency of second layer 140, decorative member 130 and first layer 136 will be at least partially visible through second layer 140, or decorative member 130 will at least be able to emit light visible to occupants of the vehicle, but may not be discernable when not emitting light. Second layer 140 may also be constructed of alternative polymeric materials such as, for example, ABS, polycarbonates, PC/ABS, phenolics, polypropylenes, or the like.

Second layer 140 is preferably formed about first layer 136 by known injection molding processes in a manner similar to the formation of first layer 136 about grip base 132, with tuck grooves 166 being formed simultaneously. Second layer 140 may be formed to a thickness of approximately 2.3 to 2.7 millimeters relative to first layer 136, with first layer 136 sized to obtain a pre-specified overall design diameter of steering wheel 120. For example, the portion of base member 134 to which second layer 140 is to be applied may be positioned within a mold having a mold cavity designed to form a desired size and shape for second layer 140 and tuck grooves 166. A polymeric material may then be injected into the mold cavity such that second layer 140 and tuck grooves 166 are formed. Upon removal, excess polymeric material may be trimmed off if necessary. Rather than forming tuck grooves 166 during the molding process, however, tuck grooves 166 may also be alternatively formed by machining processes, such as, for example, grinding, boring, drilling, broaching, milling, or honing, after second layer has been applied about first layer.

As previously noted, FIGS. 2A and 8 disclose that decorative member 130 does not completely fill groove 152. When second layer 140 is formed in the manner described above, therefore, the injected polymeric material of second layer 140 will “fill” around decorative member 130, thereby aiding in the retention of decorative member 130 within groove 152. However, if decorative member 130 is alternatively constructed to either completely fill or partially extend out of groove 152, the injected polymeric material of second layer 140 would generally cover decorative member 130 rather than fill there around.

Although disclosed as a unitary piece fully encapsulating first layer 136 between spaced ends 150 of first layer 136, it should be understood that second layer 140 may be alternatively constructed and still function as intended within the scope of the present invention. For example, spaced ends 150 of first layer 136 could be exposed, with tuck grooves 166 being formed on either first or second layer 136, 140. Optionally, second layer 140 may be formed such that one or more arc-shaped portions or sections of first layer 136 are not covered by second layer 140. The exposed sections of first layer 136 may then be covered with an opaque material or covering to create the affect of several separate spaced sections of second layer 140, first layer 136, and decorative member 130. Still further, as described in more detail below, two or more configurations of the first layer 136, decorative member 130, and second layer 140 illustrated in FIG. 11 could be included on an alternative steering wheel 120. For example, one such configuration could be disposed in an approximately ten o'clock to two o'clock relative orientation and a second such configuration disposed in an approximately four o'clock to eight o'clock relative orientation. A single second layer 140 may also be optionally formed to fully surround grip base 132, with base arms 146 extending out of second layer 140. Furthermore, second layer 140 may be alternatively formed such that it does not fully surround the cross-sectional profile of first layer 136 such that one or more gaps or spaces are present on second layer 140 that may be filled with another material or the like.

Although first grip portion 122 is shown as having a single insert layer or first layer 136 with a decorative member 130 located within a groove 152 formed in first layer 136 and a cover layer or second layer 140 encapsulating the first layer 136, it should be understood that alternative configurations and numbers of layers could be constructed and still function as intended. For example, a cover layer 140 could be disposed about two or more separate insert layers 136, or an insert layer 136 can be disposed about a layer that is in contact with grip base 132 and that does not include a cavity. Optionally, an alternative steering wheel could be constructed wherein two or more insert layers 136 are separated by translucent or transparent layers that do not include a cavity for receiving a decorative member 130. Furthermore, a steering wheel could have both an opaque insert layer 136 and one or more translucent or transparent insert layers 136 disposed about the opaque insert layer 136 in a multi-layered fashion. Additionally, the outer surface of first layer 136 could include patterns or designs that are molded or machined onto the surface that would be visible through second layer 140, with the patterns constructed as dimples, striations, lines, or the like.

As shown in FIGS. 1A, 2A, and 12, coating 142 is applied over second layer 140, where coating 142 is generally translucent. In the illustrated embodiment, coating 142 is produced using a water-soluble transfer film 168 having a pre-selected ink pattern 170 printed on the transfer film 168. Generally, to apply the ink pattern 170 onto the second layer 140, the transfer film 168 is subjected to a wetting procedure and the second layer 140 is caused to come into contact with the transfer film 168, thus causing the transfer film 168 with the ink pattern 170 to be deposited onto the second layer 140. A residual portion of the transfer film 168 is then washed from second layer 140 with the ink pattern 170 remaining thereon at a thickness of, for example, approximately 1 to 2 microns. When dry, a transparent sealer or protecting coat or clear coat, such as top coat 773 of FIG. 17, may then be applied over the ink pattern 170 at, for example, a thickness of approximately 45 to 80 microns to provide protection and may also provide a glossy appearance, or a non-reflective appearance, or the like.

One method of applying the ink pattern 170 of transfer film 168 to second layer 140 is accomplished by a liquid pressure transfer method, which generally involves floating a sheet of the transfer film 168 on the surface of a liquid and bringing the second layer 140 into contact with the transfer film 168 while it is floating on the liquid. U.S. Pat. Nos. 6,599,579 and 6,022,438, assigned to Cubic Co., Ltd, disclose examples of liquid pressure transfer methods used to apply such a transfer film 168 to at least a portion of a steering wheel, and are hereby incorporated herein by reference in their entirety. It should be understood, however, that other liquid pressure transfer methods besides those disclosed in U.S. Pat. Nos. 6,599,579 and 6,022,438 may be used to create coating 142, as well as other methods not involving liquid pressure. For example, alternative coatings 142 could be applied by spray coating or dipping processes, and may be paint, lacquer, varnishes, or the like. Still further, a coating may even be omitted without affecting the scope of the present invention.

In the embodiment shown, the ink pattern 170 is selected to enable coating 142 to portray a wood grain type appearance by way of multiple lines 172 (FIG. 2A). The locations between lines 172 may be either translucent or transparent such that second layer 140 and decorative member 130 are visible there through, with the translucent or transparent second layer 140 helping to produce a three-dimensional appearance to the wood grain pattern. Although disclosed as having a wood grain type appearance, it should be understood that numerous other types and styles of coatings 142 may be applied to second layer without affecting the function of the coating 142 within the scope of the present invention. Coating 142 may be designed to have, for example, a tortoise shell appearance, spotted appearance, or a series of parallel, spiraled, or crisscrossed lines, or the like. Furthermore, coating 142 may not include a pattern, but merely be a transparent or translucent layer, such as a lacquer, varnish, or protective polymeric wrapping, adapted to provide a glossy appearance and/or protection to first grip portion 122. Coating 142 may even be completely omitted from second layer.

FIGS. 1 and 1A further illustrate that steering wheels 20, 120 may be alternatively constructed to include additional separate and spaced first grip portions 22A, 122A (shown in phantom), with first grip portions 22A, 122A being constructed in similar manner to first grip portions 22, 122 described above. As illustrated, first grip portions 22, 122 are circumferentially disposed in an arc of approximately ten o'clock to two o'clock relative orientation about grip bases 32, 132 and first grip portions 22A, 122A are disposed in an approximately four o'clock to eight o'clock relative orientation, with second grip portions 24, 124 thus being disposed in the approximately two o'clock to four o'clock and eight o'clock to ten o'clock relative orientations between first grip portions 22, 22A and 122, 122A. Furthermore, it should be appreciated that steering wheels 20, 120 may also be constructed to include three or more such separate and spaced first grip portions 22, 122 and still function as intended within the scope of the present invention. Still further, although not shown, an alternative steering wheel could be constructed to include both a first grip portion 122 including a decorative member 130 and a separate and spaced first grip portion 22 not including a decorative member.

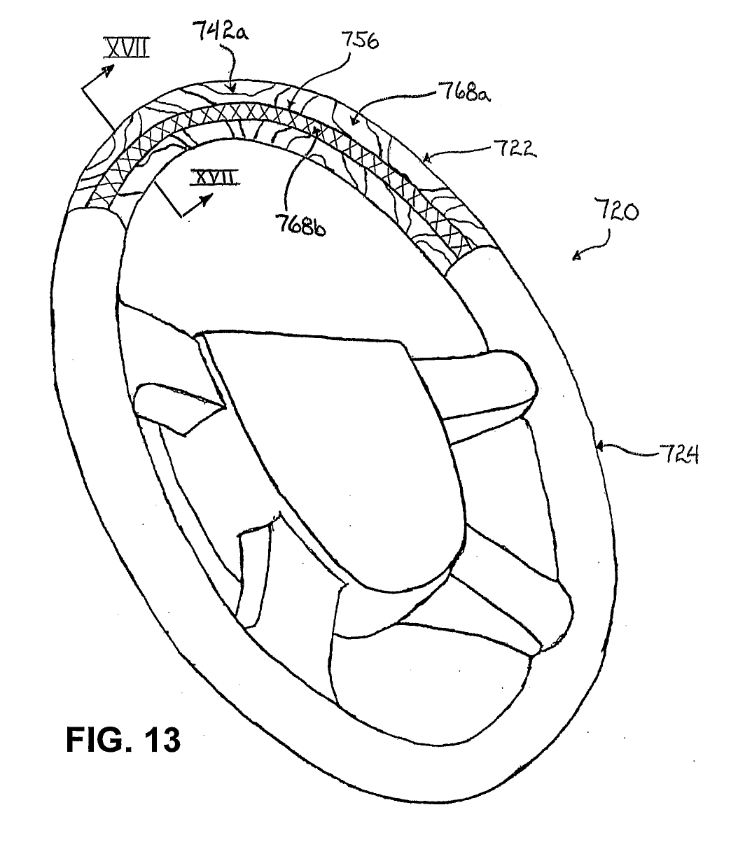

Referring now to FIGS. 13-17, a steering wheel 720 is illustrated that is of similar construction to the above discussed steering wheels 20, 120. The similar components or elements of steering wheel 720 are shown with similar reference numbers as used in FIGS. 1 and 2 with respect to steering wheel 20, but with 700 added to the reference numbers in FIGS. 13-17, and are shown with similar reference numbers as used in FIGS. 1A, 2A, 4, 8, 11, and 12 with respect to steering wheel 120, but with 600 added to the reference numbers in FIGS. 13-17. It should be understood that, because of the similarity of the illustrated steering wheels 20, 120, 720, not all of the specific construction and alternatives of like referenced parts will be discussed in the following discussion of steering wheel 720.

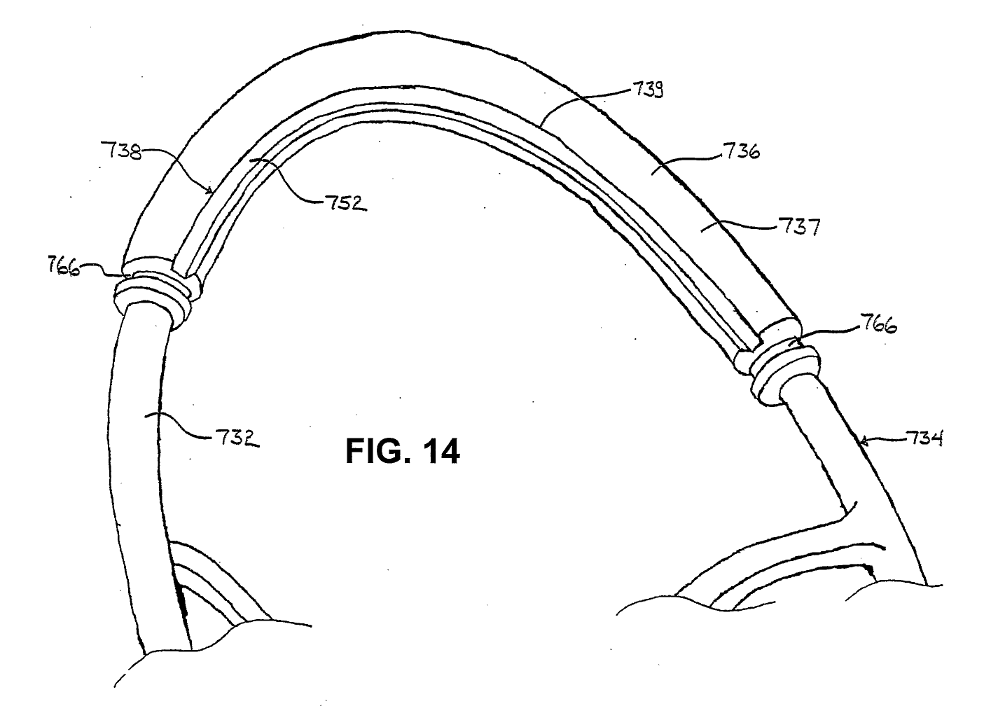

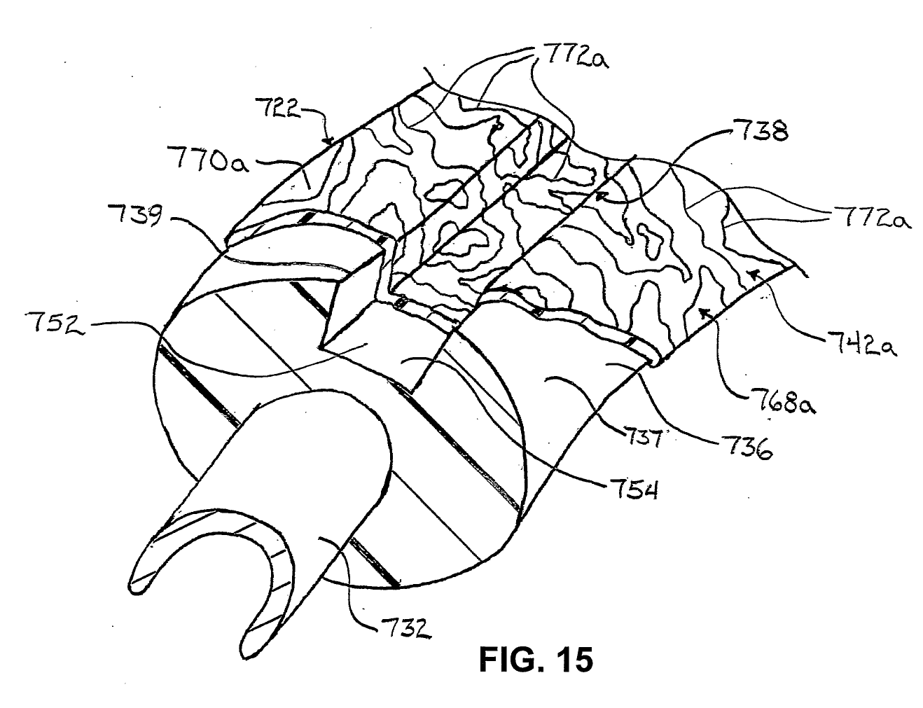

Steering wheel 720 includes a first grip portion 722 and a second grip portion 724, with first grip portion 722 including a decorative member, which in the illustrated embodiment is an ornamental insert or inlay member 756. First grip portion 722 includes a first layer or insert layer 736 (FIGS. 14 and 15), but in contrast to steering wheels 20 and 120 above, does not include a second layer or cover layer of molded translucent or transparent, polymeric or plastic material disposed about insert layer 736. The inlay member 756, when disposed within the cavity 738 which is formed as a notch, recess, channel or groove 752 of insert layer 736, therefore, is disposed generally proximate the outer surface of first grip portion 722. Cavity 738 forms an opening 739 in the outer surface 737 of insert layer 736. When so installed, the inlay member 756 is generally flush with the insert layer 736. However, inlay member may be alternatively raised or recessed with respect to the insert layer.

FIG. 14 discloses insert layer 736 disposed about grip base 732 of base member 734. As noted above and described in more detail below, insert layer 736 includes groove 752 for receiving inlay member 756. Insert layer 736 also includes tuck grooves 766 for receiving, securing and interconnecting with portions of second grip portion 724. Insert layer 736 may be formed from acrylonitrile butadiene styreme polycarbonate (ABS-PC) or another polymeric or plastic material, such as poly carbonate, ABS, phenollic, or polypropylene, and may be formed to be transparent or translucent. Insert layer 736 may be formed to have an outer diameter to obtain a pre-specified overall design diameter of steering wheel 720. Groove 752 and/or tuck grooves 766 may be formed by a mold while molding insert layer 736 about grip base 732 or, alternatively, may be formed by a separate machining operation. Although not shown, first layer 736 may also include conventional finger recesses or grip areas on the rear portion.

Upon forming insert layer 736 about grip base 732, as illustrated in FIG. 15, a decorative coating or coating 742a may be applied to insert layer 736. In the illustrated embodiment, coating 742a is a transfer film 768a having a pre-selected ink pattern 770a printed on the transfer film 768a, which may be applied by a liquid pressure transfer method as described above to result in an ink pattern 770a thickness of approximately 1 to 2 microns. Various differently styled ink patterns 770a may be selected for application to insert layer 736 to produce a variety of surface appearances. For example, ink pattern 770a may be selected to create a wood grain appearance on insert layer 736, or may be selected to create a spotted appearance, a tortoise shell appearance, or a series of parallel, spiraled, crisscrossed, or interwoven lines, or the like.

When insert layer 736 is formed of a transparent or translucent layer, transfer film 768a may provide a desirable three-dimensional type appearance to steering wheel 720 by including transparent or translucent film areas between lines 772a. Transfer film 768a may, however, alternatively not include transparent or translucent film areas such that transfer film 768a is completely opaque and fully hides or covers insert layer 736, or portions thereof, whereby insert layer 736 is generally not visible through transfer film 768a. In that case, insert layer 736 need not be formed of a transparent or translucent material.

In the illustrated embodiment of FIG. 15, coating 742a is applied about the entire circumference of insert layer 736 such that the coating 742a is also within groove 752. Alternatively, however, coating 742a may be omitted from groove 752 without affecting the scope of the present invention. For example, groove 752 may be masked prior to applying coating 742a such that coating 742a is not applied, either entirely or partially, within groove 752.

Still further, alternative coatings 742a and/or coating application methods may be utilized within the scope of the present invention. For example, alternative coatings could be applied by spray coating or dipping processes, and may be paint, lacquer, varnishes, or the like. Still further, a coating may even be omitted without affecting the scope of the present invention.

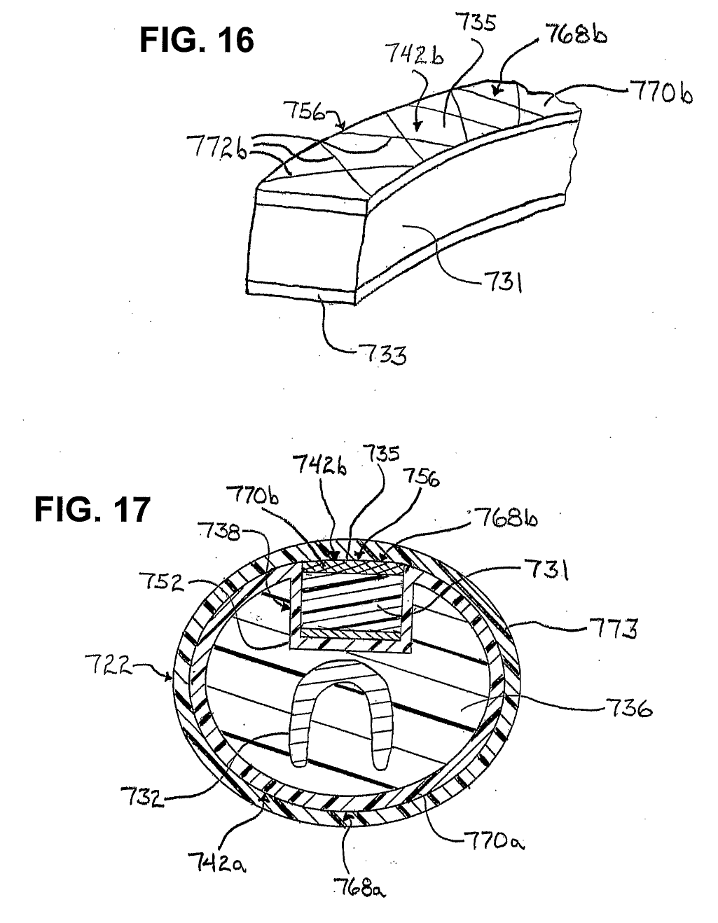

Referring now to FIG. 16, the illustrated inlay member 756 is shown to include a base member 731, a backing member 733, and a decorative coating or coating 742b, with backing member 733 forming the base and decorative coating 742b forming the outer surface or exposed surface 735 of inlay member 756. The illustrated inlay member 756 has a generally square cross sectional profile of approximately 3×3 millimeters and extends along the entire arc of insert layer 736. It should be appreciated, however, that alternative inlay members may have varying cross sectional dimensions and be disposed in alternative arrangements and/or spans about the insert layer. Base member 731 is formed as a translucent or transparent material formed of, for example, molded polycarbonate, but may alternatively be made from other polymeric or plastic materials or by alternative methods.

Backing member 733, in the illustrated embodiment, is a silver paint applied to the transparent or translucent base member 731 to provide a reflective surface. Alternatively, however, backing member 733 may be a reflective tape or metallic material adhered to base member 731, or other type or color of reflective paint. Still further, such a backing member may alternatively be applied to the base 754 (FIG. 15) of groove 752 on top of or in place of coating 742a. As noted, backing member 733 provides a reflective surface that provides a depth appearance to inlay member 756 when viewing through the transparent or translucent material of base member 731. It should be appreciated, therefore, that alternative inlay members having opaque base members, such as base members formed of opaque polymeric or plastic materials, need not include such backing members.

Coating 742b, similar to coating 742a, is formed as a transfer film 768b having a pre-selected ink pattern 770b printed on the transfer film 768b, and which may be applied by a liquid pressure transfer method as described above. In like manner, therefore, various differently styled ink patterns 770b may be selected for application to inlay member 756 to produce a variety of surface appearances, such as a tortoise shell appearance, a wood grain appearance, a spotted appearance, various line type appearances, or the like.

In the illustrated embodiment, with base member 731 formed from a transparent or translucent material, ink pattern 770b includes a series of lines 772b and is generally translucent or transparent between lines 772b such that base member 731 is visible through transfer film 768b. The transparent or translucent base member 731, backing member 733, and ink pattern 770b thus help to provide inlay member 756 with a generally three-dimensional appearance.

Although coating 742b is disclosed as a transfer film 768b, it should be appreciated that alternative coatings and/or coating methods may be applied to inlay member 756 within the scope of the present invention. For example, alternative coatings could be applied by spray coating or dipping processes, and may be paint, lacquer, varnishes, or the like. Still further, a coating may even be omitted without affecting the scope of the present invention. Although FIG. 16 discloses coating 742b as being located only on the top surface of inlay member 756, it should also be appreciated that coating 742b may also be applied about the sides or completely surround inlay member 756.

Inlay member 756 of FIG. 16 is separately formed from insert layer 736 and coating 742a disposed about grip base 732, with inlay member 756 then being subsequently installed to groove 752 of insert layer 736. Inlay member 756 may be retained within groove 752 by an adhesive or may be retained by a press fit type engagement, mechanical fasteners, clips, tabs, or the like. Referring now to FIG. 17, a generally transparent coating layer or top coat 773 is then applied to the exposed coating 742b of assembled inlay member 756 and outer coating 742a on insert layer 736. The top coat 773, which may be a clear coat type paint finish deposited to a thickness of approximately 45 to 80 microns, provides protection to the transfer film 768a disposed about the insert layer 736 and to the transfer film 768b disposed on base member 731. Top coat 773 may also provide steering wheel 720 with a more lustrous appearance, or may be selected to provide an anti-glare feature or characteristic. Alternatively, however, a separate top coat may be applied to both insert layer 736 and decorative member 730 or inlay member 756 prior to assembly of the decorative member 730 into the insert layer 736. An additional top coat (not shown) may then be applied to the assembly.

Steering wheel 720 is able to provide unique visually aesthetic styling details for a vehicle to which steering wheel 720 is installed. The materials for insert layer 736 and base member 731, as well as coatings 742a, 742b, may be selected to provide numerous different color and pattern combinations for steering wheel 720. For example, base member 731 may be formed from a generally translucent material and provided with a tortoise shell pattern transfer film 768b, while insert layer 736 is provided with a pale or blonde type wood grain transfer film pattern 768a. Alternatively, base member 731 may be formed from a generally opaque material, such that backing member may be omitted, and provided with a pale or blonde type wood grain transfer film pattern 768b, while insert layer 736 is formed from a generally translucent material and is provided with a darker wood grain transfer film pattern 768a.

Although steering wheel 720 is disclosed as including a decorative member formed as an inlay member 756 having a coating 742b and a backing member 733 sandwiched about a base member 731, it should be appreciated that alternative decorative members may be utilized within the scope of the present invention. For example, decorative members formed as light-emitting devices, such as light-emitting devices of generally similar construction and function as light-emitting devices 156, 556 and/or 656 described above, may be installed within groove 752 of insert layer 736, or may be installed into one or more alternatively formed cavities in insert layer such that both inlay member 756 and one or more light-emitting devices are used simultaneously in the same steering wheel. Similarly, alternatively formed ornamental inserts may be utilized with steering wheel 720 such as, for example, inserts formed of a metallic material, such as copper, or a colored polymeric material selected to provide a visual contrast relative to the appearance of insert layer 736 and/or match the interior color of a vehicle. Ornamental inserts may even be formed of transparent material, such as transparent acrylic material, or the like.

It should also be appreciated that steering wheel 720 may be formed having an insert layer with alternative numbers of cavities and/or alternatively formed cavities. For example, steering wheel 720 may include an insert layer having cavities of generally similar construction to cavities 238, 338, or 438 of FIGS. 5 to 7. Correspondingly, such a steering wheel may include one or more decorative members for insertion into such cavities, with the decorative members being formed to include a base member, a coating layer, and an optional backing member in generally similar manner to inlay member 756 described above, or may be constructed as light-emitting devices, or as other alternative ornamental inserts, or the like.

Furthermore, although steering wheel 720 is shown having a single insert layer 736 and a single first grip portion 722 extending over a limited arc of grip member 734, it should be understood that steering wheel 720 may alternatively be constructed, for example, with respect to the first grip portion and insert layer. For example, the steering wheel may have more than one first grip portion and/or insert layer about the grip member

It should also be understood that steering wheel 720 may incorporate more than one insert layer about the arc of grip base of base member and/or that the insert layer may not fully surround the grip base. Also, while exposed surface 735 of decorative member 730 is illustrated as being generally flush with opening 739 of insert layer 736, it should also be appreciated that alternatively styled and sized decorative members may be disposed within the cavity 738 of insert layer 736. For example, a decorative member may extend out of the cavity or be recessed within or have side-to-side spacing relative to the walls of the cavity. It should also be understood that an insert layer may have alternative numbers and shaped cavities, as described above.

An alternative steering wheel (not shown) of similar construction to that of steering wheel 20 may be constructed using an elastomeric or resilient material to form a first layer, with the elastomeric or resilient material being adapted to provide absorption of impact forces. A second layer may then be disposed about the first layer, with the second layer providing a gripping location for the driver of the vehicle to hold with respect to the steering wheel. The second layer may also be constructed of an elastomeric or resilient material. The elastomeric or resilient material would provide a cushioning effect to occupants of vehicles that are involved in accidents and whom are caused to forcefully contact the steering wheel. Such an alternative steering wheel may or may not include a cavity and decorative member in first layer.

Still further, an alternative steering wheel may include a thin, strip-like light-emitting device in contact with the armature and a transparent first layer substantially encapsulating or covering the light-emitting device where the first layer does not include or only includes a shallow cavity due to the configuration of the light-emitting device, and having a transparent or translucent second layer. A first layer may also be alternatively constructed from one or more separately formed sections that are adapted to receive a decorative member and which are then securable to or around the armature prior to molding a transparent or translucent second layer about the first layer. Additionally, a decorative member formed by winding a strand or positioning a mesh style netting about the outer surface of the first layer and molding a transparent or translucent second layer over the strand or netting may also be alternatively employed.

The steering wheel of the present invention enhances the vehicle to which it is installed by adding visibly distinguishing content to the interior of the vehicle while forming a segment of the grip portion of the steering wheel. The additional content of the steering wheel may include an inner layer that is visible through a transparent or translucent cover layer. The inner layer may be colored to compliment the interior of the vehicle and may also include patterns or details on an outer surface that are visible through the cover layer. The cover layer may be tinted with colors and may also include a decorative coating. The additional content of the steering wheel may also include a decorative member, such as either a light-emitting device or an ornamental insert installed within the steering wheel. The decorative members may be installed within one or more cavities on an inner layer that is visible through a transparent or translucent cover, or may be installed within one or more cavities on an insert layer that is not encapsulated by a cover layer. The decorative member constructed as a light-emitting device may also provide functional benefits by supplying added light to the occupants of a vehicle when the occupants are entering or exiting the vehicle, or by functioning as a map light, or as a turn signal indicator, or in other ways. Numerous differently styled decorative members constructed as ornamental inserts may be used to provide various aesthetically appealing additions to the steering wheel. When included, the second layer or cover layer may be either transparent or translucent, and may be optionally tinted with hues adapted to compliment the coloring of the interior of the vehicle. The application of a decorative coating to the steering wheel provides further visual distinguishing design details.

Changes and modifications in the specifically described embodiments can be carried out without departing from the principles of the present invention, which is intended to be limited only by the scope of the appended claims, as interpreted according to the principles of patent law including the doctrine of equivalents.

1. A steering wheel for vehicles, said steering wheel comprising:
a steering wheel base member, said steering wheel base member including a grip base; and
a grip portion, said grip portion being at least partially disposed about said grip base, said grip portion comprising;
an insert layer, said insert layer being at least partially disposed about said grip base, said insert layer including a cavity, said cavity forming an opening on an outer surface of said insert layer; and
a decorative member, said decorative member being approximately the same size and shape as said cavity;
said decorative member being positioned within said cavity such that said decorative member is substantially contained within said cavity and such that said decorative member includes an exposed surface relative to said insert layer, said decorative member and said insert layer being at least partially visible when said decorative member is disposed within said cavity.

2. The steering wheel of claim 1, wherein said decorative member comprises an inlay member having an inlay base member and a coating disposed on said base member, said coating being disposed at least on said exposed surface of said inlay member.

3. The steering wheel of claim 2, wherein said inlay base member is at least one of generally translucent and transparent, and wherein said coating is at least one of partially translucent and transparent.

4. The steering wheel of claim 3, further comprising a backing member opposite said exposed surface of said inlay member, said backing member being located on at least one of said inlay base member and said cavity.

5. The steering wheel of claim 2, wherein said coating comprises a transfer film, said transfer film including a transfer pattern.

6. The steering wheel of claim 1, further comprising a coating disposed on at least a portion of said outer surface of said insert layer.

7. The steering wheel of claim 6, wherein said insert layer is at least one of generally translucent and transparent, and wherein said coating is at least one of partially translucent and transparent.

8. The steering wheel of claim 6, wherein said coating comprises a transfer film, said transfer film including a transfer pattern.

9. The steering wheel of claim 1, further comprising a coating at least partially disposed about at least one of said outer surface of said insert layer and said exposed surface of said decorative member, said coating comprising a transfer film including a transfer pattern.

10. The steering wheel of claim 9, further comprising a top coat, said top coat being at least partially disposed about said grip portion.

11. The steering wheel of claim 1, wherein said decorative member comprises a light-emitting device.

12. The steering wheel of claim 1, further comprising a cover layer, said cover layer being disposed about at least a portion of said insert layer such that said decorative member is substantially encapsulated by said cover layer within said cavity, said cover layer being adapted to enable said decorative member to be at least partially visible.

13. The steering wheel of claim 12, wherein said decorative member comprises at least one chosen from an ornamental insert and a light-emitting device.

14. The steering wheel of claim 12, further comprising a coating disposed at least partially about said cover layer, wherein said coating is adapted to enable said decorative member to be at least partially visible.

15. The steering wheel of claim 14, wherein said coating comprises a transfer film, said transfer film including a transfer pattern.

16. A method of producing a steering wheel, said method comprising:
providing a steering wheel base member having a grip base;
forming an insert layer about at least a portion of said grip base;
forming a cavity in said insert layer, said cavity defining an opening on an outer surface of the insert layer;
providing a decorative member for installation to the steering wheel, said decorative member being approximately the same size and shape as said cavity; and
inserting said decorative member into said cavity such that said decorative member is substantially contained within said cavity and such that said decorative member includes an exposed surface relative to said insert layer.

17. The method of claim 16, wherein the decorative member is selected from an inlay member and a light-emitting device.

18. The method of claim 16, including forming a coating at least partially disposed about at least one of said outer surface of said insert layer and said exposed surface of the decorative member.

19. The method of claim 18, wherein said coating comprises a transfer film including a transfer pattern.

20. The method of claim 16, wherein at least one of said insert layer and said decorative member are at least one of partially translucent and transparent.

21. The method of claim 16, including forming a cover layer about at least a portion of said insert layer such that said decorative member is substantially encapsulated by said cover layer within said cavity, said cover layer being adapted to enable said decorative member to be at least partially visible.

22. The method of claim 21, including providing a coating disposed at least partially about said cover layer, said coating being adapted to enable said decorative member to be at least partially visible.

23. The steering wheel of claim 22, wherein said coating comprises a transfer film, the transfer film including a transfer pattern.
